(19) United States
(12) Patent Application Publication
(10) Pub. No.: US 2021/0063551 A1
(43) Pub. Date: Mar. 4, 2021

(54) ULTRASONIC SENSOR

(71) Applicant: KABUSHIKI KAISHA TOSHIBA, Minato-ku (JP)

(72) Inventors: Tomio ONO, Yokohama (JP); Yasuharu HOSONO, Kawasaki (JP); Mitsunaga SAITO, Inzai (JP)

(73) Assignee: KABUSHIKI KAISHA TOSHIBA, Minato-ku (JP)

(21) Appl. No.: 16/815,066

(22) Filed: Mar. 11, 2020

(30) Foreign Application Priority Data
Aug. 28, 2019 (JP) 2019-155962

(51) Int. Cl. G01S 7/521; G01S 15/04; G01S 15/931

(52) U.S. Cl. CPC G01S 7/521; G01S 15/931; G01S 15/04

(57) ABSTRACT

According to one embodiment, an ultrasonic sensor includes first and second elements. A first operation is performed. The first operation includes processing based on first and second signals. The first signal corresponds to a first reflected wave of a first ultrasonic wave and is obtained from the first elements. The second signal corresponds to the first reflected wave and is obtained from N_{R2} of the second elements (N_{R2} being an integer of 3 or more) included in the second elements. The first elements are arranged along a first direction at a first pitch p_{R1}. The N_{R2} second elements are arranged at a pitch of the second elements. A component in the first direction of the pitch of the second elements is a second pitch p_{R2}. p_{R2}/p_{R1} is not less than 0.97 times and not more than 1.03 times (N_{R2}+j)/N_{R2}.

### CROSS-REFERENCE TO RELATED APPLICATIONS

This application is based upon and claims the benefit of priority from Japanese Patent Application No. 2019-155962, filed on Aug. 28, 2019; the entire contents of which are incorporated herein by reference.

### FIELD

Embodiments described herein relate generally to an ultrasonic sensor.

### BACKGROUND

There is an ultrasonic sensor using an ultrasonic wave. It is desirable for the ultrasonic sensor to have a wide detection region.

### BRIEF DESCRIPTION OF THE DRAWINGS

FIG. 1 is a schematic plan view illustrating an ultrasonic sensor according to a first embodiment;

FIG. 2A to FIG. 2C are graphs illustrating characteristics of an ultrasonic sensor;

FIG. 3A to FIG. 3C are graphs illustrating characteristics of the ultrasonic sensor according to the embodiment;

FIG. 4 illustrates characteristics of the ultrasonic sensor;

FIG. 5 illustrates characteristics of the ultrasonic sensor;

FIG. 6 illustrates characteristics of the ultrasonic sensor;

FIG. 7A and FIG. 7B are schematic views illustrating characteristics of an ultrasonic sensor according to a second embodiment;

FIG. 8 is a schematic plan view illustrating an ultrasonic sensor according to a third embodiment;

FIG. 9 is a schematic plan view illustrating an ultrasonic sensor according to a fourth embodiment;

FIG. 10A to FIG. 10C are schematic views illustrating characteristics of ultrasonic sensors;

FIG. 11 is a schematic plan view illustrating an ultrasonic sensor according to the fourth embodiment;

FIG. 12 is a schematic plan view illustrating an ultrasonic sensor according to the fourth embodiment;

FIG. 13A and FIG. 13B are schematic cross-sectional views illustrating the ultrasonic sensor according to the embodiment;

FIG. 14 is a schematic view showing a usage example of the ultrasonic sensor according to the embodiment; and

FIG. 15 is a schematic view showing a usage example of the ultrasonic sensor according to the embodiment.

### DETAILED DESCRIPTION

According to one embodiment, an ultrasonic sensor includes a plurality of first elements, and a plurality of second elements. A first operation is performed. The first operation includes processing based on a first signal and a second signal. The first signal corresponds to a first reflected wave of a first ultrasonic wave and is obtained from the plurality of first elements. The second signal corresponds to the first reflected wave and is obtained from N_{R2} of the second elements (N_{R2} being an integer of 3 or more) included in the plurality of second elements. The first elements are arranged along a first direction at a first pitch p_{R1}. The first pitch p_{R1} is in the first direction. The N_{R2} second elements are arranged at a pitch of the plurality of second elements. A component in the first direction of the pitch of the plurality of second elements is a second pitch p_{R2}. p_{R2}/p_{R1} is not less than 0.97 times and not more than 1.03 times (N_{R2}+j)/N_{R2}. j is not n·N_{R2}/m. m is an integer not less than 1 and not more than k. n is an integer not less than 1 and not more than (m−1). j is an integer not less than 1 and not more than (N_{R2}−1). k is an integer not less than 2 and not more than 6.

According to one embodiment, an ultrasonic sensor includes a plurality of first elements, and a plurality of second elements. A first operation is performed. The first operation includes processing based on a first signal and a second signal. The first signal corresponds to a first reflected wave of a first ultrasonic wave and is obtained from the plurality of first elements. The second signal corresponds to the first reflected wave and is obtained from N_{R2} of the second elements (N_{R2} being an integer of 3 or more) included in the plurality of second elements. The first elements are arranged along a first direction at a first pitch p_{R1}. The first pitch p_{R1} is in the first direction. The N_{R2} second elements are arranged at a pitch of the plurality of second elements. A component in the first direction of the pitch of the plurality of second elements is a second pitch p_{R2}. N_{R2}, the first pitch p_{R1}, and the second pitch p_{R2} satisfy

p_{R2}/p_{R1}=(N_{R2}+j)/N_{R2} (1), and

j≠n·N_{R2}/m (2).

m is an integer not less than 1 and not more than k. n is an integer not less than 1 and not more than (m−1). j is an integer not less than 1 and not more than (N_{R2}−1). k is an integer not less than 2 and not more than 6.

According to one embodiment, an ultrasonic sensor includes a plurality of elements. A first operation is performed. The first operation includes processing based on a first signal and a second signal. The first signal corresponds to a first reflected wave of a first ultrasonic wave and is obtained from a plurality of first elements. The first elements are a portion of the plurality of elements. The second signal corresponds to the first reflected wave and is obtained from N_{R2} second elements (N_{R2} being an integer of 3 or more). The N_{R2} second elements are a portion of the plurality of elements. The first elements are arranged along a first direction at a first pitch p_{R1}. The first pitch p_{R1} is in the first direction. The N_{R2} second elements are arranged at a pitch of the N_{R2} second elements. A component in the first direction of the pitch of the N_{R2} second elements is a second pitch p_{R2}. p_{R2}/p_{R1} is not less than 0.97 times and not more than 1.03 times (N_{R2}+j)/N_{R2}. j is not n·N_{R2}/m. m is an integer not less than 1 and not more than k. n is an integer not less than 1 and not more than (m−1). j is an integer not less than 1 and not more than (N_{R2}−1). k is an integer not less than 2 and not more than 6.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

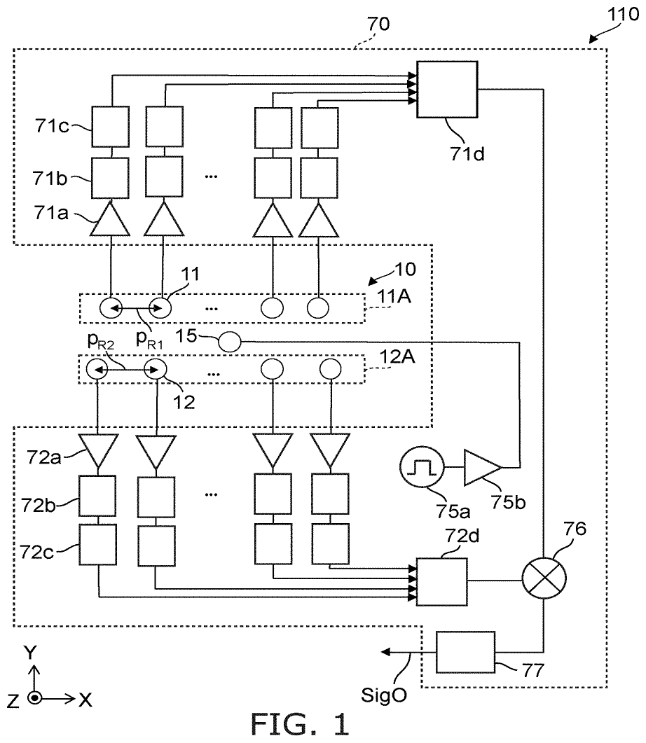

FIG. 1 is a schematic plan view illustrating an ultrasonic sensor according to a first embodiment.

As shown in FIG. 1, the ultrasonic sensor 110 according to the embodiment includes multiple first elements 11 and multiple second elements 12. In the example, the ultrasonic sensor 110 further includes a transmitting element 15.

The multiple first elements 11 are included in a first element array 11A. The multiple second elements 12 are included in a second element array 12A. The first element array 11A and the second element array 12A are included in an element part 10.

The multiple first elements 11 are arranged in a first direction at a first pitch p_{R1} which is in the first direction. The first direction is taken as an X-axis direction. One direction perpendicular to the X-axis direction is taken as a Z-axis direction. A direction perpendicular to the X-axis direction and the Z-axis direction is taken as a Y-axis direction.

For example, the multiple second elements 12 are arranged at the pitch of the multiple second elements 12. The component in the first direction (the X-axis direction) of the pitch of the multiple second elements 12 is a second pitch p_{R2}. In the example shown in FIG. 1, the multiple second elements 12 are arranged along the first direction (the X-axis direction). In such a case, the second pitch p_{R2}, which is the pitch of the multiple second elements 12, is a length along the first direction (the X-axis direction).

In the embodiment, the direction in which the multiple second elements 12 are arranged may be oblique to the first direction. In such a case, the pitch (the first-direction component) of the multiple second elements 12 corresponds to the second pitch p_{R2} when the direction in which the multiple second elements 12 are arranged is projected along the first direction. To simplify the description hereinbelow, the direction in which the multiple second elements 12 are arranged is taken to be the first direction. The direction in which the multiple second elements 12 are arranged is substantially parallel to the direction in which the multiple first elements 11 are arranged.

In the example, the ultrasonic sensor 110 includes a processor 70. In one example, the processor 70 includes a signal source 75a, a drive amplifier 75b, multiple first preamplifiers 71a, multiple first A/D converters 71b, multiple first delay circuits 71c, a first adder circuit 71d, multiple second preamplifiers 72a, multiple second A/D converters 72b, multiple second delay circuits 72c, a second adder circuit 72d, a multiplication circuit 76, and a low-pass filter 77.

The output of the signal source 75a is supplied to the drive amplifier 75b. The output of the drive amplifier 75b is supplied to the transmitting element 15.

One of the multiple first preamplifiers 71a is electrically connected to one of the multiple first elements 11. One of the multiple first A/D converters 71b is electrically connected to one of the multiple first preamplifiers 71a. One of the multiple first delay circuits 71c is electrically connected to one of the multiple first A/D converters 71b. The first adder circuit 71d is electrically connected to the multiple first delay circuits 71c.

One of the multiple second preamplifiers 72a is electrically connected to one of the multiple second elements 12. One of the multiple second A/D converters 72b is electrically connected to one of the multiple second preamplifiers 72a. One of the multiple second delay circuits 72c is electrically connected to one of the multiple second A/D converters 72b. The second adder circuit 72d is electrically connected to the multiple second delay circuits 72c.

The output of the first adder circuit 71d and the output of the second adder circuit 72d are supplied to the multiplication circuit 76. The output of the multiplication circuit 76 is supplied to the low-pass filter 77. The output of the low-pass filter 77 is output as an output signal SigO.

For example, a signal is output from the signal source 75a. The signal is supplied to the transmitting element 15 via the drive amplifier 75b. An ultrasonic wave (e.g., a first ultrasonic wave) is radiated from the transmitting element 15. The ultrasonic wave that is radiated from the transmitting element 15 is, for example, isotropic.

The radiated first ultrasonic wave is reflected by an object. The object is to be detected by the ultrasonic sensor 110. A reflected wave (a first reflected wave) that is obtained due to the reflection is incident on the multiple first elements 11 and the multiple second elements 12.

A first signal (a received signal) that corresponds to the first reflected wave is obtained by the multiple first elements 11. The first signal is supplied to the first adder circuit 71d via the first preamplifiers 71a, the first A/D converters 71b, and the first delay circuits 71c. A second signal (a received signal) that corresponds to the first reflected wave is obtained by the multiple second elements 12. The second signal is supplied to the second adder circuit 72d via the second preamplifiers 72a, the second A/D converters 72b, and the second delay circuits 72c. The result of the multiplication of the output of the first adder circuit 71d and the output of the second adder circuit 72d by the multiplication circuit 76 is output via the low-pass filter 77. The output signal SigO that is obtained from the low-pass filter 77 includes, for example, the envelope characteristic of the received signal.

The transmitting element 15 is, for example, an ultrasonic transducer for transmitting. The multiple first elements 11 and the multiple second elements 12 are, for example, receiving elements. The multiple first elements 11 and the multiple second elements 12 are, for example, ultrasonic transducers for receiving.

The following first operation is performed by the ultrasonic sensor 110. For example, the first operation is performed by the processor 70. In the first operation, the first ultrasonic wave is radiated from the transmitting element 15. In the first operation, processing is performed based on the first signal obtained from the multiple first elements 11 and based on the second signal obtained from N_{R2} second elements 12 (N_{R2} being an integer of 3 or more) included in the multiple second elements 12. The first signal is a signal corresponding to the first reflected wave of the first ultrasonic wave. The second signal also is a signal corresponding to the first reflected wave of the first ultrasonic wave.

As described above, the multiple first elements 11 are arranged in the first direction (the X-axis direction) at the first pitch p_{R1} which is in the first direction. The N_{R2} second elements 12 are arranged at the pitch of the multiple second elements 12. The first-direction component of the pitch of the multiple second elements 12 is the second pitch p_{R2}. In the example, the N_{R2} second elements 12 are arranged along the first direction.

m is taken to be an integer not less than 1 and not more than k. n is taken to be an integer not less than 1 and not more than (m−1). j is taken to be an integer not less than 1 and not more than (N_{R2}−1). Practically, k is, for example, an integer not less than 2 and not more than 6. In the embodiment, the number N_{R2}, the first pitch p_{R1}, and the second pitch p_{R2} satisfy the relationships

p_{R2}/p_{R1}=(N_{R2}+j)/N_{R2} (1), and

j≠n·N_{R2}/m (2).

Practically, for example, p_{R2}/p_{R1} may be not less than 0.97 times and not more than 1.03 times (N_{R2}+j)/N_{R2}. In such a case as well, j is not n·N_{R2}/m.

A large detection range is obtained thereby. For example, a wide field of view is obtained.

An example of characteristics of the ultrasonic sensor will now be described.

An array of a reference example including multiple transmitting elements and multiple receiving elements is, for example, a phased array. In an acoustical far-field range, a directivity D of the phased array is given by the product of an array factor AF and an element factor EF (referring to Formula (3)). The array factor AF is determined by an element pitch p and a number N of elements. The element factor EF is determined by the configuration (e.g., the diameter) of the element.

D(θ)=AF(θ)·EF(θ) (3)

The angle θ is the zenith angle. The angle θ is an angle in the X-Z plane and is an angle referenced to the Z-axis direction. For example, the angle θ is 0 in a direction perpendicular to the multiple transmitting elements and the multiple receiving elements.

Using an array factor AF_{T} of the transmitting element array, a directivity D_{T} of the transmission is given by

D_{T}=AF_{T}·EF.

Using an array factor A_{FR} of the receiving element array, a directivity [symbol] of the reception is given by

D_{R}=AF_{R}=EF.

A directivity D_{TR} of the transmission and reception is given by the following Formula (4).

$$\begin{matrix}{D}_{T R} = {O}_{T} \cdot {D}_{R} \\ = ( {AF}_{T} \cdot EF ) \cdot ( {AF}_{R} \cdot EF ) \\ = ( A {F}_{T} \cdot {AF}_{R} ) \cdot ( {EF}^{2} ) \\ = {AF}_{TR} \cdot {EF}_{T R}\end{matrix} \qquad ( 4 )$$

“AF_{TR}” is the array factor of the transmission and reception. “EF_{TR}” is the element factor of the transmission and reception.

For example, the number of the multiple transmitting elements is taken as a number N_{T}; and the number of the multiple receiving elements is taken as a number N_{R}. The pitch of the multiple transmitting elements is taken as a pitch p_{T}; and the pitch of the multiple receiving elements is taken as a pitch p_{R}.

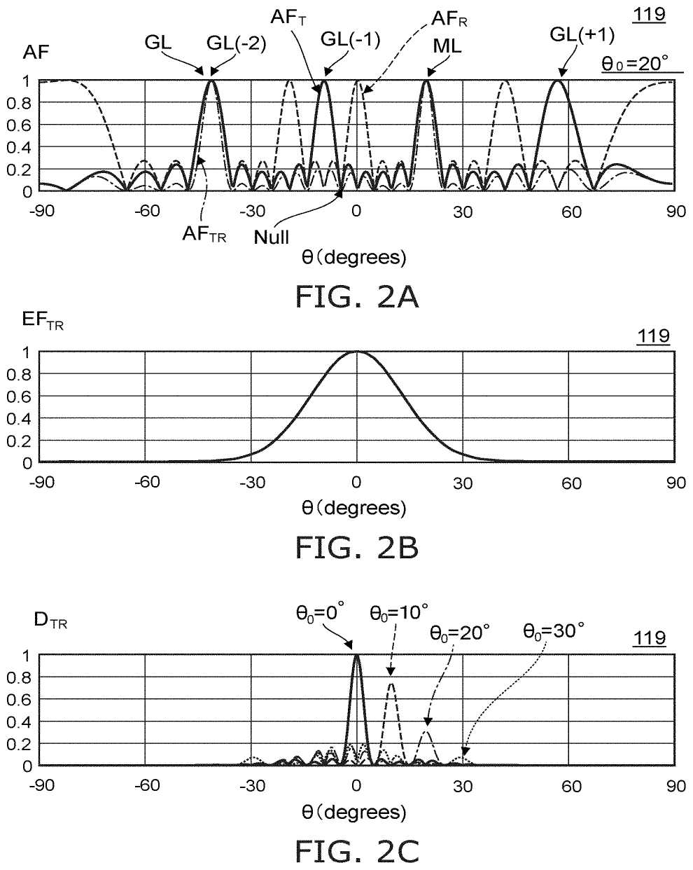

FIG. 2A to FIG. 2C are graphs illustrating characteristics of an ultrasonic sensor.

These drawings illustrate characteristics of an ultrasonic sensor 119 of the reference example. In the ultrasonic sensor 119 of the reference example, an ultrasonic wave is transmitted from multiple transmitting elements; and a reflected wave is received by multiple receiving elements. In the ultrasonic sensor 119, the number N_{T} is 6. The number N_{R} is 4. The pitch p_{T} is 2λ. The pitch p_{R} is 3λ. λ is the wavelength of the ultrasonic wave. The element pitch ratio (=p_{R}/p_{T}) is 3/2. The diameters of the transmitting elements and the receiving elements are 1.92. A frequency f of the ultrasonic wave is 40 kHz. In such a case, the wavelength λ is about 8.3 mm.

In FIG. 2A to FIG. 2C, the horizontal axis is the angle θ. The vertical axis of FIG. 2A is the array factor AF. The vertical axis of FIG. 2B is an element factor EF_{TR} of the transmission and reception. The vertical axis of FIG. 2C is the directivity D_{TR} of the transmission and reception. FIG. 2A corresponds to the characteristics when a deflection angle θ₀ is 20 degrees. The deflection angle θ₀ is an angle referenced to the Z-axis direction.

The array factor AF_{T} of the transmitting element array, the array factor A_{FR} of the receiving element array, and the array factor AF_{TR} of the transmission/reception array are shown in FIG. 2A. The array factor AF_{TR} of the transmission/reception array is the product of the array factor AF_{T} of the transmitting element array and the array factor A_{FR} of the receiving element array. The array factor AF_{T} of the transmitting element array corresponds to “p_{T}/λ=2”. The array factor A_{FR} of the receiving element array corresponds to “p_{R}/λ, =3”.

In the example as shown in FIG. 2A, a peak exists when the angle θ is the deflection angle θ₀ of 20°. The peak corresponds to a main lobe ML. There are other peaks when the angle θ is angles other than 20°. The other peaks that have the same height as the main lobe ML correspond to grating lobes GL. The points where the value of the vertical axis is substantially 0 correspond to “Null”.

A −1 order grating lobe GL (the grating lobe GL(−1)) is in the region at the left of the main lobe ML in FIG. 2A. A −2 order grating lobe GL (the grating lobe GL(−2)) is at the left of the grating lobe GL(−1). There are other grating lobes GL as well. A first-order grating lobe GL (the grating lobe GL(+1)) is in the region at the right of the main lobe ML. −1 order, −2 order, . . . , “Null” are in order of decreasing proximity to the main lobe ML in the region at the left of the main lobe ML. +1 order, +2 order, . . . , “Null” are in order of decreasing proximity to the main lobe ML in the region at the right of the main lobe ML. For example, the grating lobes GL are visible as virtual images in an image generated by scanning an ultrasonic beam. Good detection is possible by setting the grating lobes GL substantially not to exist in the field of view.

In the ultrasonic sensor 119, the condition of “p_{T}/λ=2” and the condition of “p_{R}/λ=3” are employed. In such a case, the angles θ of the ±1 order grating lobes GL of the transmitting element match the angles θ of “Null” of the receiving elements. In such a case, the grating lobe GL of the array factor AF_{TR} of the transmission and reception disappears at the angles θ corresponding to the ±1 order grating lobes GL of the transmitting element. On the other hand, the grating lobe GL of the array factor AF_{TR} of the transmission and reception does not disappear at the angle θ corresponding to the −2 order grating lobe GL of the transmitting element. This angle θ is about 40°.

In the example, the element factor EF_{TR} of the transmission and reception such as that shown in FIG. 2B is applied. In such a case, the element factor EF_{TR} of the transmission and reception is small at the angle θ (about)−40° corresponding to the −2 order grating lobe GL of the transmitting element. The element factor EF_{TR} of the transmission and reception at the angle θ of about 40° is substantially 0.

Accordingly, as shown in FIG. 2C, the directivity D_{TR} of the transmission and reception is low at this angle θ (about −40°). Thus, for the directivity D_{TR} of the transmission and reception, the peak that corresponds to the −2 order grating lobe GL of the transmitting element substantially does not occur.

The directivity D_{TR} of the transmission and reception when the deflection angle θ₀ is 0° to 30° is shown in FIG. 2C. In the range where the deflection angle θ₀ is 0° to 20°, an unnecessary peak corresponding to a grating lobe GL substantially does not occur. Peaks remain when the deflection angle θ₀ exceeds this range. Thus, when the deflection angle θ₀ is 20° or less, the effects of the grating lobes GL can be suppressed; and the ultrasonic beam can be deflected.

However, in the ultrasonic sensor 119, the angles at which deflection is possible are 40° or less (±20° or less). The range of the angles at which deflection is possible is narrow. Therefore, the field of view is narrow.

On the other hand, in the ultrasonic sensor 110 according to the embodiment, the reception is performed by the multiple first elements 11 and the multiple second elements 12. The array factor of the first element array 11A including the multiple first elements 11 is taken as AF₁. The array factor of the second element array 12A including the multiple second elements 12 is taken as AF₂. The directivity is given by the following.

DT=EF

D_{R1}=EF·AF₁

D_{R2}=EF·AF₂

D_{TR1}=D_{T}·D_{R1}=EF²·AF₁

D_{TR2}=D_{T}·D_{R2}=EF²·AF₂ (5)

D_{TR1} is the directivity of the transmission and reception of the first element array 11A. D_{TR2} is the directivity of the transmission and reception of the second element array 12A.

Multiplying the directivity D_{TR1} of the transmission and reception of the first element array 11A and the directivity D_{TR2} of the transmission and reception of the second element array 12A gives

D_{TR}=D_{TR1}×D_{TR2}=⁴·(AF₁·AF₂) (6).

For example, the suppression of the grating lobes GL is performed at (AF₁·AF₂). Thereby, in the ultrasonic sensor 110 according to the embodiment, the grating lobes GL can be suppressed.

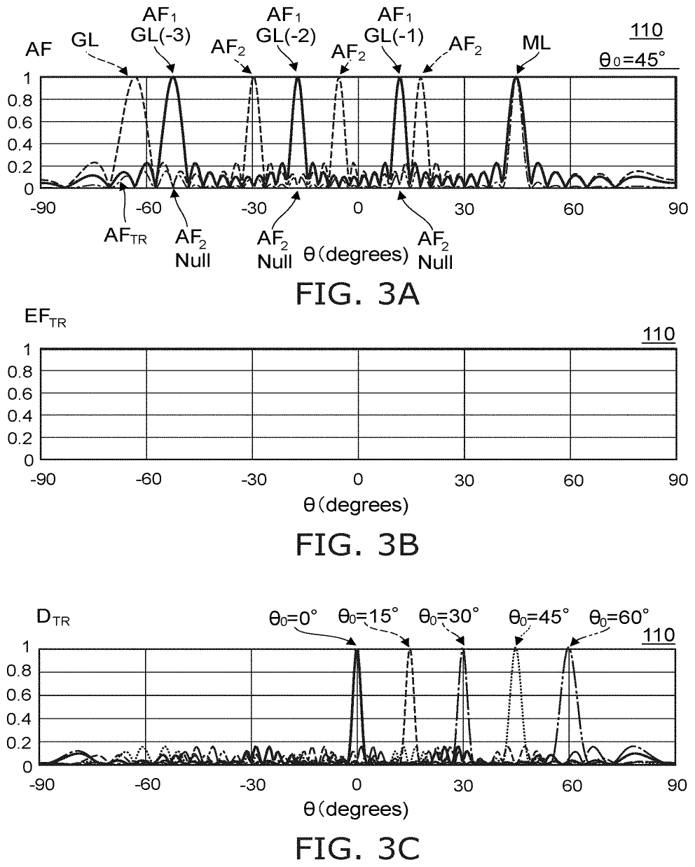

FIG. 3A to FIG. 3C are graphs illustrating characteristics of the ultrasonic sensor according to the embodiment.

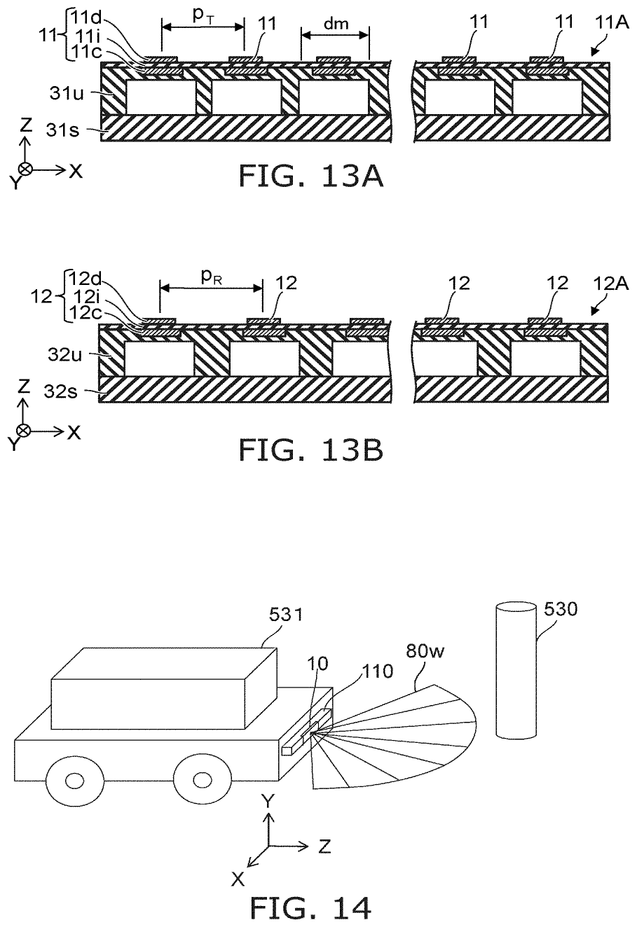

These drawings illustrate characteristics of the ultrasonic sensor 110 according to the embodiment. In the ultrasonic sensor 110, a number N_{R1} is 10. The number N_{R2} is 8. The first pitch p_{R1} is 2λ. The second pitch p_{R2} is 2.52. is the wavelength of the ultrasonic wave. The element pitch ratio (=p_{R2}, p_{R1}) is 5/4. Diameters dm of the multiple first elements 11 and the multiple second elements (referring to FIG. 13A) each are 0.62. The frequency f of the ultrasonic wave is 40 kHz. In such a case, the wavelength λ is about 8.3 mm.

In FIG. 3A to FIG. 3C, the horizontal axis is the angle θ. The vertical axis of FIG. 3A is the array factor AF. The vertical axis of FIG. 3B is the element factor EF_{TR} of the transmission and reception. To simplify the description in the example, the element factor EF_{TR} of the transmission and reception is taken to be 1. In the embodiment, for example, the element factor EF_{TR} of the transmission and reception when the deflection angle θ₀ is 45 degrees may be not less than 1/2 (or not less than 0.7 times) of the element factor EF_{TR} of the transmission and reception when the deflection angle θ₀ is 0 degrees. The vertical axis of FIG. 3C is the directivity D_{TR} of the transmission and reception. The characteristics of FIG. 3A correspond to the characteristics when the deflection angle θ₀ is 45 degrees.

The array factor AF₁ of the first element 11, the array factor AF₂ of the second element 12, and the array factor AF_{TR} of the transmission and reception are shown in FIG. 3A. As shown in FIG. 3A, a −1 order grating lobe GL, a −2 order grating lobe GL, and a −3 order grating lobe GL occur for the array factor AF₁ of the first element 11. The angles θ where these grating lobes GL occur substantially match the angles θ where “Null” of the array factor AF₂ of the second element 12 occurs. Therefore, the grating lobes GL are suppressed for the array factor AF_{TR} of the transmission and reception. The high-order grating lobes GL can be suppressed.

As shown in FIG. 3C, the effects of the grating lobes GL can be suppressed in the range where the deflection angle θ₀ is 0° to 60°. The ultrasonic beam can be deflected in the wide range of angles of 0° to 60°. Thereby, the object can be detected in a wide angle range. According to the embodiment, an ultrasonic sensor that has a wide detection region can be provided. A wide field of view is obtained.

In the ultrasonic sensor 119, the directivity D_{TR}(θ) is proportional to (EF(θ))². On the other hand, in the ultrasonic sensor 110, the directivity D_{TR}(θ) is proportional to (EF(θ))⁴. In the ultrasonic sensor 110, it is favorable for the element factor EF(θ) to be substantially 1. A wide directivity is obtained easily thereby. For example, it is favorable for the transmitting element 15 to be capable of radiating an isotropic ultrasonic wave with wide directivity. In the embodiment, high-speed data acquisition is possible using one transmission.

An example of the processing of the signal by the ultrasonic sensor 110 will now be described. The ultrasonic wave that is reflected by the object is incident on the first element array 11A and the second element array 12A. Received signals are generated by the first element array 11A and the second element array 12A.

For example, the received signal that is generated by the first element array 11A is amplified by the first preamplifier 71a, subsequently converted into a digital signal by the first A/D converter 71b, and stored in, for example, memory. The converted digital signal undergoes delay processing by the first delay circuit 71c, and subsequently is added by the first adder circuit 71d. The signal of the ultrasonic wave arriving at the deflection angle θ₀, which is determined by the setting of the delay time, is enhanced.

For example, the received signal that is generated by the second element array 12A is amplified by the second preamplifier 72a, subsequently converted into a digital signal by the second A/D converter 72b, and stored in, for example, memory. The converted digital signal undergoes delay processing by the second delay circuit 72c, and subsequently is added by the second adder circuit 72d. The signal of the ultrasonic wave arriving at the deflection angle θ₀, which is determined by the setting of the delay time, is enhanced. A first delay sum signal that is output from the first adder circuit 71d and a second delay sum signal that is output from the second adder circuit 72d are multiplied by the multiplication circuit 76. The multiplied signal passes through the low-pass filter 77; and the envelope of the multiplied signal is detected. For example, a luminance signal based on the envelope is generated. The luminance signal is drawn on a screen as a scanning line in the direction of the deflection angle θ₀. Multiple scanning lines are drawn on the screen by repeating the same process while changing the deflection angle θ₀. An image of the object is drawn thereby.

For example, the processing that is repeated while changing the deflection angle θ₀ is performed inside a digital signal processing system by using the received signal stored in the memory. Therefore, the number of transmissions necessary for drawing the entire image can be 1 time. High-speed data acquisition is possible thereby.

Thus, the processor 70 is configured to perform the first operation. The processor 70 is configured to output, in the first operation, the first operation signal (e.g., the output signal SigO) corresponding to the multiplication result of the signal based on a first signal and a signal based on the second signal. For example, the processor 70 multiplies a delay sum operation result of the first signal and a delay sum operation result of the second signal. The processor 70 is configured to output a signal corresponding to the multiplied result as the output signal SigO.

In the embodiment, for example, the signals received for all of the elements can be acquired using one transmission. For example, the transmission and reception time is long in the ultrasonic sensor 119 of the reference example recited above. For example, in the ultrasonic sensor 119 of the reference example, the distance from the element array to the detection region is taken as DS. The speed of sound is taken as c1. In such a case, a time Δt that is necessary for one transmission and reception is 2DS/c1. The number of scanning lines necessary for forming one screen is taken as a number Np1. A time Tm that is necessary to form one screen is obtained by Np1·Δt and is (2Np1·DS)/c1. For example, the distance DS is taken to be 2 m. The number Np1 of scanning lines is 19 when scanning a one-dimensional sector at 5° steps through a region where θ is ±45° or less. When the medium of the ultrasonic wave is air, the data acquisition time of one screen is about 0.23 seconds. For two-dimensional scanning, the number Np1 of scanning lines is 19², i.e., 361. In such a case, the data acquisition time of one screen is about 4.4 seconds. Thus, the transmission and reception time of the ultrasonic sensor 119 is long.

Conversely, in the ultrasonic sensor 110 according to the embodiment, the reflection of the ultrasonic wave is received by the first element array 11A and the second element array 12A. The signal that is received by the first element array 11A undergoes delay sum processing; and the signal that is received by the second element array 12A undergoes delay sum processing. After the delay sum processing, the multiple signals are multiplied. The data for a two-dimensional image is obtained from the signal based on the multiplication processing result. The data for generating the image is obtained using one transmission of the ultrasonic wave. High-speed two-dimensional image acquisition is possible thereby. According to the embodiment, high-speed detection is possible in addition to a wide detection region.

In the delay sum processing recited above, for example, the received signal is amplified. For example, the amplified signal is stored in memory. The delay processing is performed using the stored signal. For example, the storage and the delay processing that relate to the signal received by the first element array 11A are performed by the multiple first A/D converters 71b and the multiple first delay circuits 71c. For example, the storage and the delay processing that relate to the signal received by the second element array 12A are performed by the multiple second A/D converters 72b and the multiple second delay circuits 72c.

For the processing according to the embodiment, the aperture diameter of the element array can be changed by modifying the number of elements used in the processing. Examples of the relationship between the aperture diameter and the distance of the sound field will now be described.

The characteristics of the propagation of the ultrasonic wave are different between the acoustical near-field proximal to the element array and the acoustical far-field distal to the element array. For example, the characteristics described above hold in an acoustical far-field. It is difficult to obtain the desired characteristics in an acoustical near-field. A distance Zb between the element array and the boundary between the acoustical near-field and the acoustical far-field is represented roughly by

Zb=W²/4λ (7).

W is the aperture diameter of the element array. In the embodiment as described below, the aperture diameter W of the element array may be changed substantially. For example, the aperture diameter W of the element array can be changed by changing the number of elements used to receive. The distance Zb from the element array can be changed thereby. By changing the distance Zb, the object can be detected in a wider range.

For example, in one example according to the embodiment, the signals received for all of the elements are acquired using one transmission. Then, the aperture diameter W of the element array can be reduced by performing the processing by using a portion of the signals received for all of the elements. A proximal object can be detected thereby. The aperture diameter W of the element array can be increased by performing the processing by using the signals received for all of the elements. A proximal object can be detected thereby. Examples of such detection are described below.

An example of the suppression of the effects of the grating lobes GL will now be described.

In the ultrasonic sensor 110 according to the embodiment as described above, for example, the following Formula (1) and Formula (2) are satisfied.

p_{R2}/p_{R1}=(N_{R2}+j)/N_{R2} (1)

j·n·N_{R2}/m (2)

In such a case, the effects of the high-order grating lobes GL can be suppressed.

Such characteristics will now be described.

The array factor AF of an element array having the element number N and the pitch p is given by

$$A F ( θ ) = \frac{sin [ \frac{N π p}{λ} ( sin θ - sin {θ}_{0} ) ]}{sin [ \frac{π p}{λ} ( sin θ - sin {θ}_{0} ) ]} . \qquad ( 8 )$$

An angle θₘ where a m-order grating lobe GL (m being an integer) occurs is given by

θₘ=sin⁻¹(sin θ₀+mλ·p) (9),

where m=±1, ±2, ±3, . . . .

The angle θₘ where an n-order “Null” occurs is given by

θₙ=sin⁻¹(sin θ₀+(n/N)·λ/p) (10),

where n=±1, ±2, ±3, . . . , and n≠±N, ±2N, ±3N, . . . .

The following can be derived from Formula (9) and Formula (10) recited above.

For a first condition recited below, the angle θ of the first-order grating lobe GL of the first element array 11A and the angle θ of “Null” of the second element array 12A match each other. As the first condition, p_{R2}/p_{R1}=1, 2, 3, . . . ; n=±N_{R2}(p_{R2}/p_{R1}); and n is an integer.

For a second condition recited below, the angle θ of the second-order grating lobe GL of the first element array 11A and the angle θ of “Null” of the second element array 12A match each other. As the second condition, p_{R2}/p_{R1}=1/2, 2/2, 3/2, . . . ; n=±N_{R2}(2p_{R2}/p_{R1}); and n is an integer.

As a third condition, the angle θ of the third-order grating lobe GL of the first element array 11A and the angle θ of “Null” of the second element array 12A match each other. As the third condition, p_{R2}/p_{R1}=1/3, 2/3, 3/3, . . . ; n=±N_{R2}(3p_{R2}/p_{R1}); and n is an integer.

When the first to third conditions recited above are satisfied simultaneously, the first to third-order grating lobes GL of the first element array 11A can be suppressed simultaneously by the “Nulls” of the second element array 12A. For example, in the example shown in FIG. 3A to FIG. 3C, p_{R2}/p_{R1}=5/4; N_{R2}=8; and the first to third conditions recited above are satisfied.

For example, a condition for simultaneously suppressing high-order grating lobes GL up to the k-order (k≥2) is

p_{R2}/p_{R1}=(N_{R2}+j)/N_{R2}, and

j≠n·N_{R2}/m,

where j=1, 2, . . . , N_{R2}−1. m is an integer not less than 1 and not more than k. n is an integer not less than 1 and not more than m−1. Practically, it is sufficient to simultaneously suppress the high-order grating lobes GL up to the sixth-order. Accordingly, it is sufficient for k to be an integer not less than 2 and not more than 6.

These formulas correspond to Formula (1) and Formula (2) described above. In such a case, the high-order grating lobes GL up to the first to k-order of the first element array 11A can be suppressed simultaneously by the “Nulls” of the second element array 12A. Thereby, an appropriate detection can be performed in a wide range of deflection angles θ₀. An ultrasonic sensor that has a wide detection region can be provided.

In the ultrasonic sensor 119 illustrated in FIG. 2A to FIG. 2C, k is 1; and Formula (1) and Formula (2) recited above are not satisfied.

In the embodiment, the deflection angle θ₀ is, for example, not less than −45° and not more than +45°. An aperture diameter W_{R1} of the first element array 11A is (N_{R1}−1)·p_{R1}. An aperture diameter W_{R2} of the second element array 12A is (N_{R2}−1)·p_{R2}. Practically, it is favorable for the aperture diameter W_{R1} to be near the aperture diameter W_{R2}. Thereby, the ultrasonic sensor is compact. Practically, it is favorable for the number N_{R1} to be 16 or less and for the number N_{R2} to be 16 or less. If the numbers are excessively high, the ultrasonic sensor becomes large, and the circuit configuration becomes complex. It is favorable for p_{R1}/λ to be not less than 1 and not more than 4. It is favorable for p_{R2}/p_{R1} to be greater than 1 and less than 2. An ultrasonic sensor that has a practical size is obtained easily.

For such practical conditions, examples will now be described for conditions at which the high-order grating lobes GL can be suppressed.

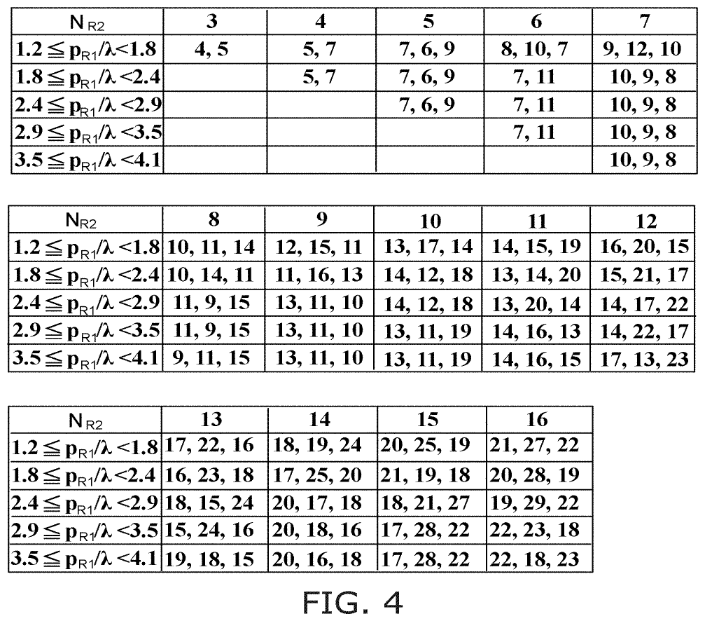

FIG. 4 illustrates characteristics of the ultrasonic sensor.

FIG. 4 illustrates the number (N_{R2}+j) at which the high-order grating lobes GL can be suppressed when the number N_{R2} is 3 to 16. In FIG. 4, “1.2 p_{R1}/λ<1.8” corresponds to the suppression of the first and second-order grating lobes GL. “1.8≤p_{R1}/λ<2.4” corresponds to the suppression of the first to third-order grating lobes GL. “2.4≤p_{R1}/λ<2.9” corresponds to the suppression of the first to fourth-order grating lobes GL. “2.9≤p_{R1}/λ<3.5” corresponds to the suppression of the first to fifth-order grating lobes GL. “3.5≤p_{R1}/λ<4.1” corresponds to the suppression of the first to sixth-order grating lobes GL. Practically, it is considered to be sufficient to suppress the first to sixth-order grating lobes GL. The top three values of the number (N_{R2}+j) having the highest suppression effect of the grating lobes GL are recited in FIG. 4. For one condition, the values are shown in order of decreasing suppression effect of the grating lobes GL from the left to the right. The suppression effect of the value at the left is higher than the suppression effect at the right.

As shown in FIG. 4, for example, it is favorable for the number (N_{R2}+j) to be 4 or 5 when the number N_{R2} is 3. For example, it is favorable for the number (N_{R2}+j) to be 10, 9, or 8 when the number N_{R2} is 7. The first to sixth-order grating lobes GL can be suppressed in such a case. For example, it is favorable for the number (N_{R2}+j) to be 22, 18, or 23 when the number N_{R2} is 16. The first to sixth-order grating lobes GL can be suppressed in such a case.

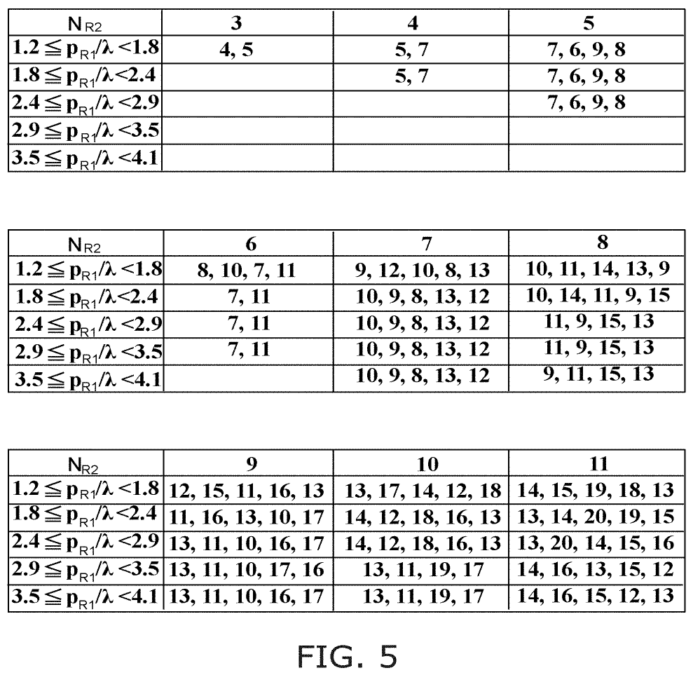

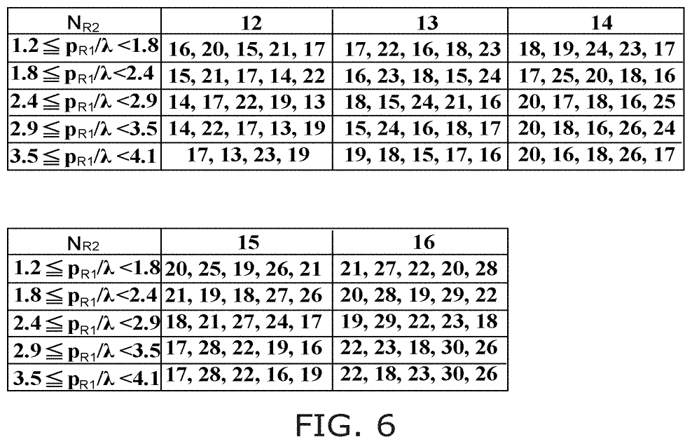

FIG. 5 and FIG. 6 illustrate characteristics of the ultrasonic sensor.

FIG. 5 illustrates the number (N_{R2}+j) at which the high-order grating lobes GL can be suppressed when the number N_{R2} is 3 to 11. FIG. 6 illustrates the number (N_{R2}+j) at which the high-order grating lobes GL can be suppressed when the number N_{R2} is 12 to 16. In FIG. 5 and FIG. 6, the top five values of the number (N_{R2}+j) having high suppression effects of the grating lobes GL are recited. For one condition, the values are shown in order of decreasing suppression effect of the grating lobes GL from the left to the right.

As shown in FIG. 6, for example, it is favorable for the number (N_{R2}+j) to be 22, 18, 23, 30, or 26 when the number N_{R2} is 16. The first to sixth-order grating lobes GL can be suppressed in such a case.

The ultrasonic sensor 110 according to the embodiment is, for example, a phased array. In a phased array, for example, different delays are provided to the transmission voltages supplied to the multiple transmitting elements. By controlling the delay time, the orientation of the ultrasonic beam sent from the element array can be controlled electronically. When receiving, the adding is performed while providing different delays to the reception voltages received by the multiple receiving elements. By controlling the delay times, the ultrasonic wave that arrives at the element array from a designated direction can be enhanced.

In the phased array, the element pitch is taken as p; and the wavelength of the ultrasonic wave is taken as λ. In a general phased array, p≤λ/2 is set to suppress the occurrence of the grating lobes GL. On the other hand, a high resolution is obtained by setting the aperture diameter W of the element array to be large. Therefore, due to the constraints of maintaining a small pitch p, the number of the multiple elements is increased to obtain a high resolution.

Conversely, in the embodiment as recited above, the effects of the grating lobes GL are suppressed. In the embodiment, for example, the effects of the grating lobes GL can be suppressed even when the element pitch p is greater than λ/2. Therefore, the aperture diameter W can be large even when the number of elements is small. A high resolution is obtained easily thereby.

For example, in the embodiment, the first pitch p_{R1} is greater than 1/2 of the wavelength of the first ultrasonic wave. For example, the second pitch p_{R2} is greater than 1/2 of the wavelength of the first ultrasonic wave. Because a large pitch can be employed, a large aperture diameter W is obtained using a small number of elements. A high resolution is obtained easily.

In the embodiment, the number N_{R2} and the number (N_{R2}+j) may include any combination illustrated in FIG. 5 and FIG. 6.

### Second Embodiment

In the second embodiment, the number N_{R2} and the number (N_{R2}+j) have a common divisor α (α being an integer of 2 or more). The number N_{R2} is the product of the common divisor α and β. In the first operation recited above, the processing is performed based on a signal obtained from the N_{R2} second elements 12. Another operation is performed in the second embodiment. The processor 70 is configured to perform, in the other operation, processing based on a signal corresponding to the reflected wave of the ultrasonic wave obtained from the multiple first elements 11 and a signal corresponding to the reflected wave obtained from β second elements 12 included in the multiple second elements 12.

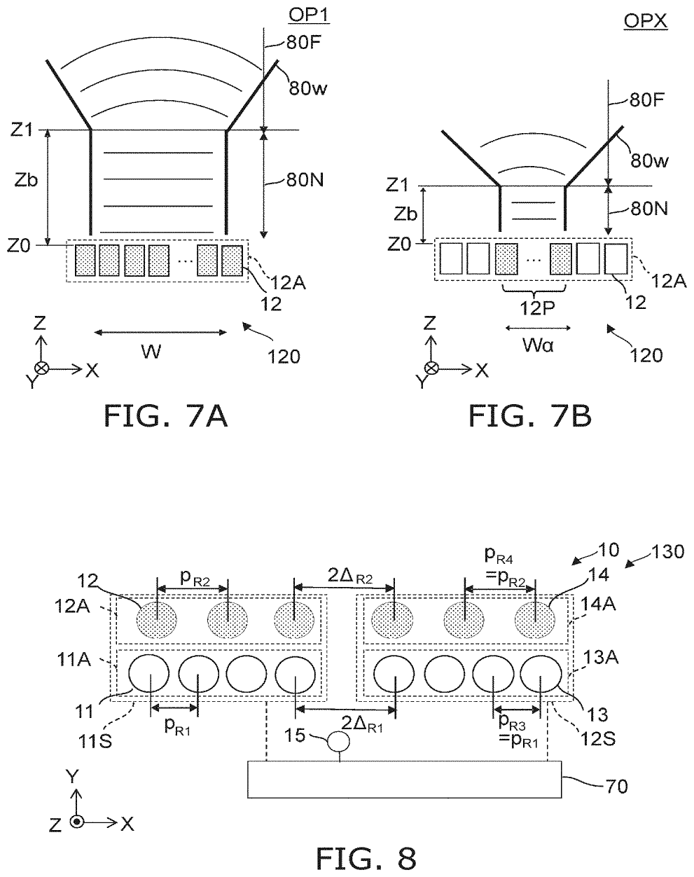

FIG. 7A and FIG. 7B are schematic views illustrating characteristics of the ultrasonic sensor according to the second embodiment.

The ultrasonic sensor 120 according to the second embodiment shown in FIG. 7A and FIG. 7B may have a configuration similar to that of the ultrasonic sensor 110 described in reference to FIG. 1. The ultrasonic sensor 120 performs the operation while changing the number of the second elements 12 used. FIG. 7A corresponds to a first operation OP1. FIG. 7B corresponds to another operation OPX.

As shown in FIG. 7A, the position in the Z-axis direction of the output end of the second element array 12A is taken as a reference position Z0. For example, when the second element array 12A is used to transmit, an ultrasonic wave 80W propagates in a plane wave configuration in an acoustical near-field 80N proximal to the reference position Z0. In an acoustical far-field 80F distal to the reference position Z0, the ultrasonic wave 80W propagates in a spherical wave configuration. The distance between the reference position Z0 and a boundary Z1 between the acoustical near-field 80N and the acoustical far-field 80F is taken as Zb. As described above, the distance Zb is given by

Zb=W²/4λ.

“W” is the aperture diameter of the second element array 12A (referring to FIG. 7A). The difference between the acoustical far-field and the acoustical near-field recited above holds also when receiving.

For example, the characteristics described in reference to the first embodiment hold for the acoustical far-field 80F. It is difficult to obtain the desired characteristics in the acoustical near-field 80N. For example, when the aperture diameter W of the second element array 12A is large, the distance Zb lengthens; and it is difficult to detect in a region proximal to the ultrasonic sensor 120.

In such a case, in the other operation OPX as shown in FIG. 7B, the reflected wave is detected by second elements 12P which are a portion of the elements included in the second element array 12A. In such a case, the aperture diameter of the second element array 12A is reduced from the aperture diameter W to an aperture diameter W/α. Thereby, the distance Zb in the operation OPX is shorter than that of the first operation OP1. The detection is easy in a region proximal to the ultrasonic sensor 120. The detection range is enlarged.

For example, a proximal region and a distal region can be detected by the first operation OP1 and the operation OPX. Both a proximal region and a distal region can be viewed.

For example, in the first operation OP1 of FIG. 7A, the number N_{R2} is 12, and p_{R2}/p_{R1}/=16/12. The grating lobes GL are suppressed at this condition. In such a case, the common divisor α is 2. In the operation OPX of FIG. 7B, N_{R2} is 6, and p_{R2}/p_{R1}=8/6. At this condition as well, the grating lobes GL are suppressed.

The distal region can be detected by twelve second elements 12 included in the second element array 12A. The proximal region can be detected by six second elements 12 included in the second element array 12A. According to the embodiment, the distal region and the proximal region can be viewed while suppressing the grating lobes GL.

For the number N_{R1} of the multiple first elements 11, the aperture diameter W_{R1} of the first element array 11A is given by (N_{R1}−1)·p_{R1}. On the other hand, the aperture diameter W_{R2} of the second element array 12A is given by (N_{R2}−1)·p_{R2}. It is sufficient to select the number N_{R1} so that the aperture diameter W_{R1} is near the aperture diameter W_{R2}.

The number N_{R2} and the number (N_{R2}+j) may have multiple common divisors α. In such a case, the aperture diameter W may be switched between three or more multilevels.

For example, for the acoustical near-field, a second reference example may be considered in which not only the deflection of the ultrasonic beam is performed, but also convergence is performed. In the second reference example, the transmission is performed while changing the convergence position. Therefore, the number of transmission and receptions increases markedly when detecting the proximal region and the distal region. The data acquisition time is long.

Conversely, in the embodiment, the detection region can be changed easily by changing the number of elements used. A wide range can be detected in a short period of time.

The operation described above can be performed by changing the number of elements that are the object of the signal processing. For example, all of the data can be acquired using one transmission. Such a dynamic aperture diameter modification may be performed in combination with the convergence of the ultrasonic beam. For example, the resolution at the proximal distance can be improved further thereby.

As shown in FIG. 4, several examples in which the number N_{R2} and the number (N_{R2}+j) have the common divisor a are as follows. When the number N_{R2} is 6, the number (N_{R2}+j) is 8 or 10. When the number N_{R2} is 8, the number (N_{R2}+A is 10 or 14. When the number N_{R2} is 9, the number (N_{R2}+j) is 12 or 15. When the number N_{R2} is 10, the number (N_{R2}+A is 12, 14, or 18. When the number N_{R2} is 12, the number (N_{R2}+A is 14, 16, 20, or 22. When the number N_{R2} is 14, the number (N_{R2}+j) is 16, 18, or 20. When the number N_{R2} is 16, the number (N_{R2}+j) is 18, 20, 22, or 28.

### Third Embodiment

FIG. 8 is a schematic plan view illustrating an ultrasonic sensor according to a third embodiment.

As shown in FIG. 8, the ultrasonic sensor 130 according to the third embodiment includes multiple third elements 13 and multiple fourth elements 14 in addition to the multiple first elements 11 and the multiple second elements 12. The ultrasonic sensor 130 may further include the processor 70. Otherwise, the configuration of the ultrasonic sensor 130 is similar to that of the ultrasonic sensor 110. For example, the processor 70 may have a configuration similar to the configuration described in reference to FIG. 1.

The multiple third elements 13 are included in a third element array 13A. The multiple fourth elements 14 are included in a fourth element array 14A. The third element array 13A and the fourth element array 14A are included in the element part 10.

The multiple third elements 13 are arranged in a second direction at the third pitch p_{R3}. In the example, the second direction is aligned with the first direction (e.g., the X-axis direction). The multiple fourth elements 14 are arranged at the pitch of the multiple fourth elements 14. The component in the second direction (in the example, the same as the first direction) of the pitch of the multiple fourth elements 14 is the fourth pitch p_{R4}. In the example, the multiple fourth elements 14 are arranged along the first direction (e.g., the X-axis direction) at the second pitch p_{R4}. In the example, the third pitch p_{R3} is substantially the same as the first pitch p_{R1}. In the example, the fourth pitch p_{R4} is substantially the same as the second pitch p_{R2}.

The processor 70 performs a second operation. The second operation includes processing based on a third signal corresponding to a second reflected wave of a second ultrasonic wave obtained from the multiple third elements 13 and based on a fourth signal corresponding to the second reflected wave obtained from N_{R4} fourth elements 14 (N_{R4} being an integer of 3 or more). mz is taken to be an integer not less than 1 and not more than kz. nz is taken to be an integer not less than 1 and not more than (mz−1). jz is taken to be an integer not less than 1 and not more than (N_{R4}−1). Practically, kz is an integer not less than 2 and not more than 6. In such a case, the number N_{R4}, the third pitch p_{R3}, and the fourth pitch p_{R4} satisfy

p_{R4}/p_{R3}=(N_{R4}+jz)/N_{R4}, and

jz≠nz·N_{R4}/mz.

Practically, p_{R4}/p_{R3} is not less than 0.97 times and not more than 1.03 times (N_{R4}+jz)/N_{R4}. Even in such a case, jz is not nz·N_{R4}/mz.

When the third pitch p_{R3} is substantially the same as the first pitch p_{R1} and the fourth pitch p_{R4} is substantially the same as the second pitch p_{R2}, the multiple third elements 13 and the multiple fourth elements 14 satisfy Formula (1) and Formula (2) recited above relating to the multiple first elements 11 and the multiple second elements 12.

In the ultrasonic sensor 130, the processor 70 is configured to perform the first operation OP1 recited above. In the first operation OP1 as described above, the detection is performed by the multiple first elements 11 and the N_{R2} second elements 12. The first operation OP1 described in reference to the first embodiment is applicable to the first operation OP1 of the third embodiment.

In the third embodiment, the processor 70 also performs the second operation. In the second operation, the detection is performed by the multiple first elements 11, the multiple second elements 12, the multiple third elements 13, and the multiple fourth elements 14.

For example, in the second operation, the processor 70 performs processing based on a signal obtained by the multiple first elements 11 and the multiple third elements 13 and a signal obtained by the N_{R2} second elements 12 and the fourth element 14 of N_{R4}.

Thus, the third embodiment switches between the first operation OP1 using the first element array 11A and the second element array 12A and the second operation using the first element array 11A, the second element array 12A, the third element array 13A, and the fourth element array 14A.

For example, the first element array 11A and the second element array 12A are included in a first subarray 11S. The third element array 13A and the fourth element array 14A are included in a second subarray 12S. The second subarray 12S has a configuration similar to that of the first subarray 11S.

For example, the number of the multiple third elements 13 is the same as the number N_{R1} of the multiple first elements 11. The number of the multiple fourth elements 14 is the same as the number N_{R2} of the multiple second elements 12. The distance along the first direction between the first-direction center of the first element 11 most proximal to the multiple third elements 13 among the multiple first elements 11 and the first-direction center of the third element 13 most proximal to the multiple first elements 11 among the multiple third elements 13 is 2Δ_{R1}. 2Δ_{R1} is different from the first pitch p_{R1}. The distance along the first direction between the first-direction center of the second element 12 most proximal to the multiple fourth elements 14 among the multiple second elements 12 and the first-direction center of the fourth element 14 most proximal to the multiple second elements 12 among the multiple fourth elements 14 is 2Δ_{R2}. 2Δ_{R2} is different from the second pitch p_{R2}.

When the first subarray 11S and the second subarray 12S operate simultaneously, the positions of the grating lobes GL match the positions of the grating lobes GL of the subarray, and the positions of the “Nulls” include the positions of the “Nulls” of the subarray.

For example, the design is performed to suppress the high-order grating lobes GL in each of the multiple subarrays. Thereby, the high-order grating lobes GL can be suppressed even when the multiple subarrays are operated simultaneously.

For example, by using two subarrays in which the high-order grating lobes GL can be suppressed, the first operation OP1 in which one subarray is operated is performed; and the second operation in which the two subarrays are operated simultaneously is performed. The aperture diameter can be modified thereby. For example, the first operation OP1 is performed when detecting at the proximal distance. For example, the second operation is performed when detecting at the distal distance. In the embodiment, for the number of subarrays may be any integer of 2 or more.

In the ultrasonic sensor 130, for example, the processor 70 is configured to output a signal corresponding to the multiplication result of a first multiplication result and a second multiplication result, in which the first multiplication result is of a signal based on the first signal (the signal obtained from the multiple first elements 11) and a signal based on the second signal (the signal obtained from the N_{R2} second elements 12), and the second multiplication result is of a signal based on the third signal (the signal obtained from the multiple third elements 13) and a signal based on the fourth signal (the signal obtained from the N_{R4} fourth elements 14).

### Fourth Embodiment

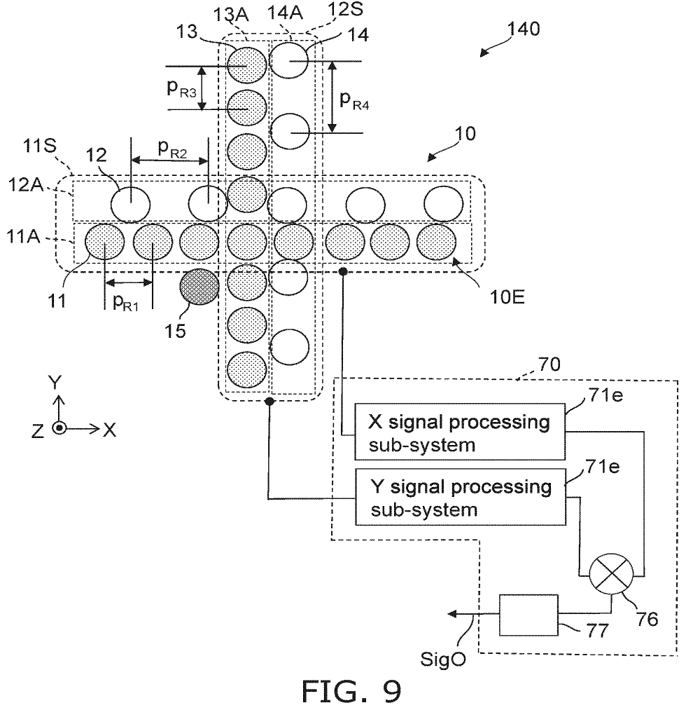

FIG. 9 is a schematic plan view illustrating an ultrasonic sensor according to a fourth embodiment.

As shown in FIG. 9, the ultrasonic sensor 140 according to the fourth embodiment includes the multiple first elements 11, the multiple second elements 12, the multiple third elements 13, and the multiple fourth elements 14. The ultrasonic sensor 140 may further include the processor 70. The configuration described in reference to the first embodiment is applicable to the multiple first elements 11 and the multiple second elements 12. As described above, the first direction in which the multiple first elements 11 and the multiple second elements 12 are arranged is aligned with the X-axis direction.

The multiple third elements 13 are arranged in the second direction at the third pitch p_{R3}; and the second direction crosses the first direction. The angle between the second direction and the first direction is, for example, not less than 80 degrees and not more than 100 degrees. The angle between the second direction and the first direction may be, for example, not less than 88 degrees and not more than 92 degrees. The second direction may be substantially perpendicular to the first direction. The second direction is, for example, the Y-axis direction.

The multiple fourth elements 14 are arranged at the pitch of the multiple fourth elements 14. The second-direction component of the pitch of the multiple fourth elements 14 is the fourth pitch p_{R4}. In the example, the fourth elements 14 are arranged along the second direction. In such a case, the fourth pitch p_{R4} is the length along the second direction (e.g., the Y-axis direction).

The processor performs the second operation. The second operation includes processing based on the third signal corresponding to the second reflected wave of the second ultrasonic wave obtained from the multiple third elements 13 and based on the fourth signal corresponding to the second reflected wave obtained from N_{R4} fourth elements 14 (N_{R4} being an integer of 3 or more). In such a case as well, mz is taken to be an integer not less than 1 and not more than kz. nz is taken to be an integer not less than 1 and not more than (mz−1). jz is taken to be an integer not less than 1 and not more than (N_{R4}−1). Practically, kz is an integer not less than 2 and not more than 6. In such a case, N_{R4}, the third pitch p_{R3}, and the fourth pitch p_{R4} satisfy

p_{R4}/p_{R3}=(N_{R4}+jz)/N_{R4}, and

jz≠nz·N_{R4}/mz.

Practically, p_{R4}/p_{R3} may be not less than 0.97 times and not more than 1.03 times (N_{R4}+jz)/N_{R4}. In such a case as well, jz is not nz·N_{R4}/mz.

For example, the first element array 11A and the second element array 12A are included in the first subarray 11S. The third element array 13A and the fourth element array 14A are included in the second subarray 12S. For example, information along the first direction relating to the object of the detection is obtained by the first subarray 11S. Information along the second direction relating to the object of the detection is obtained by the second subarray 12S.

For example, the processor 70 performs delay sum processing of the signal received by the first subarray 11S for the reflected wave of the ultrasonic wave transmitted from the transmitting element 15, and then performs multiplication processing. This processing is performed by an X signal processing sub-system 71e. Delay sum processing of the signal received by the second subarray 12S for the reflected wave of the ultrasonic wave transmitted from the transmitting element 15 is performed; and multiplication processing also is performed. This processing is performed by a Y signal processing sub-system 72e. The output signal of the X signal processing sub-system 71e and the output signal of the Y signal processing sub-system 72e are multiplied by the multiplication circuit 76. For example, the multiplication circuit 76 multiplies the signal of the X-axis direction and the signal of the Y-axis direction. The output of the multiplication circuit 76 passes through the low-pass filter 77 and is output. The output is an envelope signal including the distance information in a direction determined by the delay of the X-axis direction and the delay of the Y-axis direction. The image generation can be performed based on this result.

In the ultrasonic sensor 140 as well, the effects of the grating lobes GL can be suppressed in each of the first direction and the second direction. For example, the object can be detected in a wide angle range in each of the first direction and the second direction. In the ultrasonic sensor 140, a high-speed three-dimensional image can be generated.

In the ultrasonic sensor 140, for example, the processor 70 is configured to output a signal corresponding to a multiplication result of the first multiplication result and the second multiplication result, in which the first multiplication result is of a signal based on the first signal (the signal obtained from the multiple first elements 11) and a signal based on the second signal (the signal obtained from the N_{R2} second elements 12), and the second multiplication result is of a signal based on the third signal (the signal obtained from the multiple third elements 13) and a signal based on the fourth signal (the signal obtained from the N_{R4} fourth elements 14).

In the ultrasonic sensor 140, for example, the number N_{R1} of the first elements 11 is 8. The number N_{R2} of the second elements 12 is 6. The first pitch p_{R1} of the multiple first elements 11 is 1.52. The second pitch p_{R2} of the multiple second elements 12 is 22. The element pitch ratio (p_{R1}/p_{R2}) is 4/3. For example, a number N_{R3} of the third elements 13 is 8. The number N_{R4} of the fourth elements 14 is 6. The third pitch p_{R3} of the multiple third elements 13 is 1.52. The fourth pitch p_{R4} of the multiple fourth elements 14 is 22. The element pitch ratio (p_{R3}/p_{R4}) is 4/3. For example, the frequency f of the ultrasonic wave is 40 kHz. In such a case, the wavelength of the ultrasonic wave is 8.3 mm.

In the ultrasonic sensor 140, one of the multiple first elements 11 is shared by the first element array 11A and the third element array 13A. The transmitting element 15 is provided in the ultrasonic sensor 140. In the embodiment, the transmitting element 15 may be omitted; and the ultrasonic wave may be output by any of the multiple elements 10E (the first to fourth elements 11 to 14, etc., referring to FIG. 9).

For example, the ultrasonic sensor 140 may have the following configuration. The ultrasonic sensor 140 includes the multiple elements 10E. The multiple elements 10E include the first to fourth elements 11 to 14, etc. The ultrasonic sensor 140 performs the first operation. The first operation includes processing based on the first signal and the second signal. The first signal is a signal corresponding to the first reflected wave of the first ultrasonic wave obtained from the multiple first elements 11 which are a portion of the multiple elements 10E. The second signal is a signal corresponding to the first reflected wave obtained from the N_{R2} second elements 12 (N_{R2} being an integer of 3 or more) which are a portion of the multiple elements 10E.

The multiple first elements 11 are arranged along the first direction (e.g., the X-axis direction) at the first pitch p_{R1} which is in the first direction. The N_{R2} second elements 12 are arranged at the pitch of the N_{R2} second elements 12. The first-direction component of the pitch of the N_{R2} second elements 12 is the second pitch p_{R2}. m is taken to be an integer not less than 1 and not more than k; n is taken to be an integer not less than 1 and not more than (m−1); and j is taken to be an integer not less than 1 and not more than (N_{R2}−1). Practically, k is an integer not less than 2 and not more than 6. p_{R2}/p_{R1} is not less than 0.97 times and not more than 1.03 times (N_{R2}+j)/N_{R2}. j is not n·N_{R2}/m. For example, p_{R1}/p_{R2} is (N_{R2}+j)/N+_{R2}.

For example, the second operation is performed. The second operation includes processing based on the third signal and the fourth signal. The third signal is a signal corresponding to the second reflected wave of the first ultrasonic wave obtained from the multiple third elements 13 which are a portion of the multiple elements 10E. The fourth signal is a signal corresponding to the second reflected wave obtained from the N_{R4} fourth elements 14 (N_{R4} being an integer of 3 or more) which are a portion of the multiple elements 10E.

The multiple third elements 13 are arranged in the second direction (e.g., the Y-axis direction) at the third pitch p_{R3} which is in the second direction. The N_{R4} fourth elements 14 are arranged at the pitch of the N_{R4} fourth elements 14. The component in the second direction (e.g., the Y-axis direction) of the pitch of the N_{R4} fourth elements 14 is the fourth pitch p_{R4}. mz is taken to be an integer not less than 1 and not more than kz; nz is taken to be an integer not less than 1 and not more than (mz−1); and jz is taken to be an integer not less than 1 and not more than (N_{R4}−1). Practically, kz is an integer not less than 2 and not more than 6. p_{R4}/p_{R3} is not less than 0.97 times and not more than 1.03 times (N_{R4}+jz)/N_{R4}. jz is not nz·N_{R4}/mz. p_{R4}/p_{R3} may be (N_{R4}+jz)/N_{R4}. The angle between the second direction and the first direction is, for example, not less than 80 degrees and not more than 100 degrees.

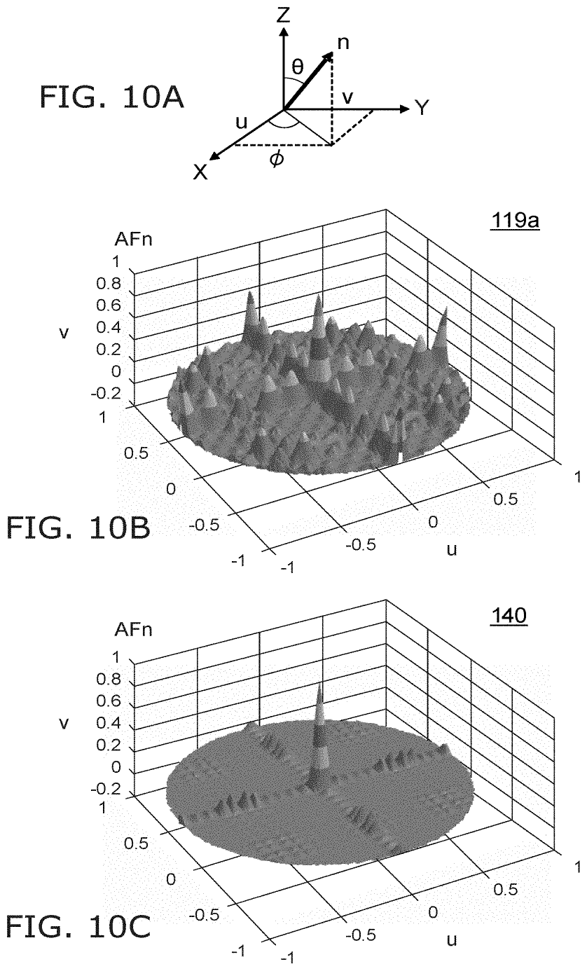

FIG. 10A to FIG. 10C are schematic views illustrating characteristics of ultrasonic sensors.

As shown in FIG. 10A, the angle θ and an angle ϕ are defined in XYZ coordinates. The angle θ corresponds to the zenith angle. The angle ϕ corresponds to the azimuth angle. “n” is a unit vector in a direction including the angle θ and the angle ϕ. A component u is the X-axis direction component of the unit vector. A component v is the Y-axis direction component of the unit vector. The deflection angle θ₀ and a deflection angle ϕ₀ correspond to the deflection angles of the ultrasonic beam, in which the following hold.

u=sin θ cos ϕ and v=sin θ sin ϕ

u₀=sin θ₀ cos ϕ₀ and v₀=sin θ₀ cos ϕ₀

FIG. 10B corresponds to the multiplied result of the sum signal of a first cross array signal and the sum signal of a second cross array signal. The sum signal of the first cross array signal includes the sum of a delay signal of a signal obtained by the first element array 11A along the X-axis direction and a delay signal of a signal obtained by the third element array 13A along the Y-axis direction. The sum signal of the second cross array signal includes the sum of a delay signal of a signal obtained by the second element array 12A along the X-axis direction and a delay signal of a signal obtained by the fourth element array 14A along the Y-axis direction. In such a case, the array factor AF_{TR} of the transmission and reception is represented by (AF_{R1}+AF_{R3})·(AF_{R2}+AF_{R4}).

FIG. 10C corresponds to the multiplied result of an X-axis direction signal obtained by multiplying the delay signal of the signal obtained by the first element array 11A along the X-axis direction and the delay signal of the signal obtained by the second element array 12A along the X-axis direction and a Y-axis direction signal obtained by multiplying the delay signal of the signal obtained by the third element array 13A along the Y-axis direction and the delay signal of the signal obtained by the fourth element array 14A along the Y-axis direction. In such a case, the array factor AF_{TR} of the transmission and reception is represented by (AF_{R1}·AF_{R3})·(AF_{R2}·AF_{R4}).

The normalized array factor AF_{TR} of the transmission and reception is taken as a normalized array factor AFn. In FIG. 10B and FIG. 10C, the vertical axis is the normalized array factor AFn. In FIG. 10B and FIG. 10A, the deflection angle θ₀ is 0 degrees; and the deflection angle ϕ₀ is 0 degrees.

As shown in FIG. 10B, grating lobes GL other than the main lobe ML occur. For example, it is considered that the grating lobes GL occur due to the interaction between the X-axis direction characteristics and the Y-axis direction characteristics. As shown in FIG. 10C, the grating lobes GL are suppressed.

In the ultrasonic sensor 140, for example, the high-order grating lobes GL can be suppressed. A wide field of view is obtained thereby. In the ultrasonic sensor 140, the proximal distance can be viewed easily using the convergence of the ultrasonic beam and a variable aperture diameter. The ultrasonic beam can be deflected two-dimensionally using one transmission. Thereby, a three-dimensional image can be generated at a high speed.

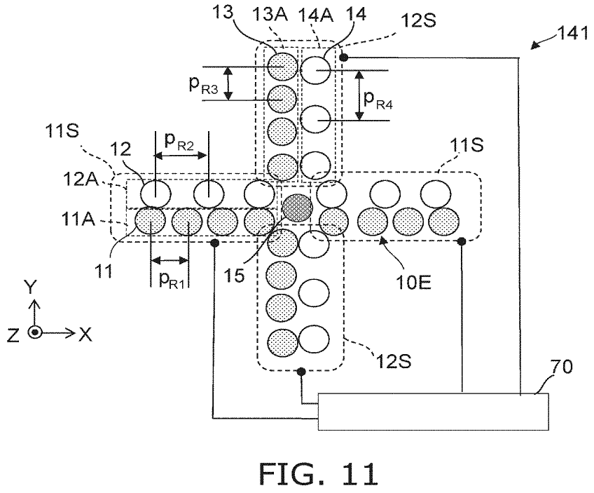

FIG. 11 is a schematic plan view illustrating an ultrasonic sensor according to the fourth embodiment.

As shown in FIG. 11, the ultrasonic sensor 141 according to the fourth embodiment includes the multiple first elements 11, the multiple second elements 12, the multiple third elements 13, and the multiple fourth elements 14. The multiple first elements 11, the multiple second elements 12, the multiple third elements 13, and the multiple fourth elements 14 are a portion of the multiple elements 10E.

The multiple first elements 11 are included in the first element array 11A. The multiple second elements 12 are included in the second element array 12A. The first element array 11A and the second element array 12A are included in the first subarray 11S. The multiple third elements 13 are included in the third element array 13A. The multiple fourth elements 14 are included in the fourth element array 14A. The third element array 13A and the fourth element array 14A are included in the second subarray 12S.

The multiple first subarrays 11S and the multiple second subarrays 12S are provided in the ultrasonic sensor 141. In the ultrasonic sensor 141, the transmitting element 15 is provided between the multiple first subarrays 11S. The transmitting element 15 is provided between the multiple second subarrays 12S. Signals that have similar characteristics are obtained in the multiple subarrays. For example, detection with higher accuracy is possible.

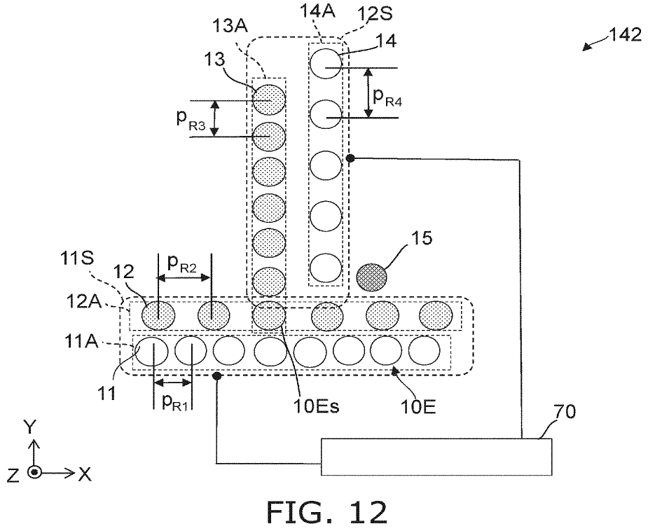

FIG. 12 is a schematic plan view illustrating an ultrasonic sensor according to the fourth embodiment.

As shown in FIG. 12, the ultrasonic sensor 142 according to the fourth embodiment includes the multiple first elements 11, the multiple second elements 12, the multiple third elements 13, and the multiple fourth elements 14. The multiple first elements 11, the multiple second elements 12, the multiple third elements 13, and the multiple fourth elements 14 are a portion of the multiple elements 10E.

In the example, an element 10Es which is one of the multiple elements 10E is shared by the first element array 11A and the third element array 13A. The ultrasonic sensor 142 includes, for example, a “T-shaped” cross array. The degrees of freedom of the transmitting element 15 are large in the ultrasonic sensor 142. Thereby, for example, the pitches of the first to fourth elements 11 to 14 are reduced easily.

In the embodiment, the ultrasonic wave (the first ultrasonic wave, etc.) may be radiated from at least one of the multiple first elements 11, from at least one of the multiple second elements 12, or from at least one of the multiple first elements 11 and at least one of the multiple second elements 12. The transmitting element 15 can be omitted in such a case.

FIG. 13A and FIG. 13B are schematic cross-sectional views illustrating the ultrasonic sensor according to the embodiment.

FIG. 13A corresponds to the first element array 11A. FIG. 13B corresponds to the second element array 12A.

As shown in FIG. 13A, one of the multiple first elements 11 includes an electrode 11c, an electrode 11d, and an intermediate layer 11i. The intermediate layer 11i is provided between the electrode 11c and the electrode 11d. The intermediate layer 11i includes, for example, a piezoelectric material, etc. The first element 11 is supported by a supporter 31u. The supporter 31u is fixed to a base body 31s. The first element 11 is separated from the base body 31s. A diaphragm that includes the intermediate layer 11i deforms in the Z-axis direction due to a voltage applied between the electrode 11c and the electrode 11d. A sound wave is produced thereby.

As shown in FIG. 13B, one of the multiple second elements 12 includes an electrode 12c, an electrode 12d, and an intermediate layer 12i. The intermediate layer 12i is provided between the electrode 12c and the electrode 12d. The intermediate layer 12i includes, for example, a piezoelectric material, etc. The second element 12 is supported by a supporter 32u. The supporter 32u is fixed to a base body 32s. The second element 12 is separated from the base body 32s. A diaphragm that includes the intermediate layer 12i deforms in the Z-axis direction when a sound wave is incident on the second element 12. An electrical signal is generated between the electrode 12c and the electrode 12d based on the deformation. This signal corresponds to the detection signal.

FIG. 14 is a schematic view showing a usage example of the ultrasonic sensor according to the embodiment.

As shown in FIG. 14, for example, the ultrasonic sensor (e.g., the ultrasonic sensor 110) according to the embodiment may be provided in an autonomous mobile robot 531. For example, an obstacle 530 that is on the path of the autonomous mobile robot 531 is detected by the ultrasonic sensor 110. In the embodiment, the detection is possible at a large deflection angle θ₀. Thereby, the distance and the direction of the obstacle 530 can be detected in a wide range. The autonomous mobile robot 531 easily can advance while avoiding the obstacle.

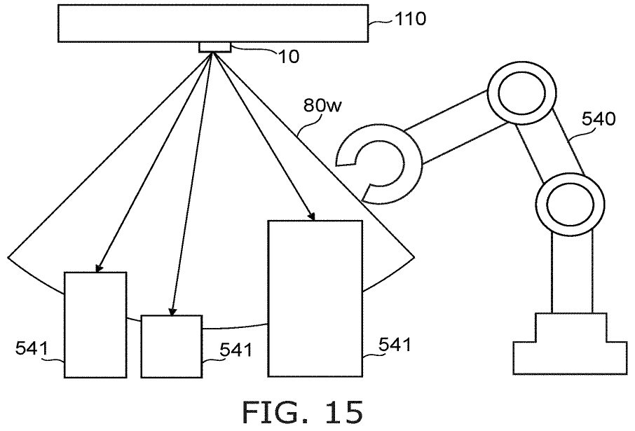

FIG. 15 is a schematic view showing a usage example of the ultrasonic sensor according to the embodiment.

The ultrasonic sensor (e.g., the ultrasonic sensor 110) according to the embodiment detects an object 541 held by a robot 540. The ultrasonic sensor 110 detects the position, the height, the configuration, etc., of the object 541. The object 541 may be light-transmissive. A wide detection region can be detected in the embodiment. The detection is high-speed. The robot 540 can hold the object 541 efficiently.

In the embodiment, the acoustic medium is, for example, air. In the embodiment, the acoustic medium may be, for example, any gas, any liquid, or any solid.

For example, the ultrasonic sensor according to the embodiment is used to detect an obstacle in the surroundings. For example, the ultrasonic sensor is used to recognize the configuration of the object. The ultrasonic sensor that uses an ultrasonic wave can detect a transparent object. The ultrasonic sensor is inexpensive and has few limits of use.

The embodiments include the following configurations (e.g., technological proposals).

Configuration 1

An ultrasonic sensor, comprising:

a plurality of first elements; and

a plurality of second elements,

a first operation being performed, the first operation including processing based on a first signal and a second signal, the first signal corresponding to a first reflected wave of a first ultrasonic wave and being obtained from the plurality of first elements, the second signal corresponding to the first reflected wave and being obtained from N_{R2} of the second elements (N_{R2} being an integer of 3 or more) included in the plurality of second elements,

the plurality of first elements being arranged along a first direction at a first pitch p_{R1}, the first pitch p_{R1} being in the first direction,

the N_{R2} second elements being arranged at a pitch of the plurality of second elements, a component in the first direction of the pitch of the plurality of second elements being a second pitch p_{R2},

p_{R2}/p_{R1} being not less than 0.97 times and not more than 1.03 times (N_{R2}+j)/N_{R2}, j not being n·N_{R2}/m, m being an integer not less than 1 and not more than k, n being an integer not less than 1 and not more than (m−1), j being an integer not less than 1 and not more than (N_{R2}−1), k being an integer not less than 2 and not more than 6.

Configuration 2

An ultrasonic sensor, comprising:

a plurality of first elements; and

a plurality of second elements,

a first operation being performed, the first operation including processing based on a first signal and a second signal, the first signal corresponding to a first reflected wave of a first ultrasonic wave and being obtained from the plurality of first elements, the second signal corresponding to the first reflected wave and being obtained from N_{R2} of the second elements (N_{R2} being an integer of 3 or more) included in the plurality of second elements,

the plurality of first elements being arranged along a first direction at a first pitch p_{R1}, the first pitch p_{R1} being in the first direction,

the N_{R2} second elements being arranged at a pitch of the plurality of second elements, a component in the first direction of the pitch of the plurality of second elements being a second pitch p_{R2},

N_{R2}, the first pitch p_{R1}, and the second pitch p_{R2} satisfying

p_{R2}/p_{R1}=(N_{R2}+j)/N_{R2} (1), and

j≠n·N_{R2}/m (2),

m being an integer not less than 1 and not more than k,

n being an integer not less than 1 and not more than (m−1),

j being an integer not less than 1 and not more than (N_{R2}−1),

k being an integer not less than 2 and not more than 6.

Configuration 3

The ultrasonic sensor according to Configuration 1 or 2, further comprising a transmitting element, the first ultrasonic wave being radiated from the transmitting element.

Configuration 4

The ultrasonic sensor according to Configuration 1 or 2, wherein the first ultrasonic wave is radiated from at least one of the plurality of first elements, from at least one of the plurality of second elements, or from at least one of the plurality of first elements and at least one of the plurality of second elements.

Configuration 5

The ultrasonic sensor according to any one of Configurations 1 to 4, further comprising a processor configured to perform the first operation,

the processor being configured to output, in the first operation, a first operation signal corresponding to a multiplication result, the multiplication result being of a signal based on the first signal and a signal based on the second signal.

Configuration 6

The ultrasonic sensor according to Configuration 5, wherein the processor multiplies a delay sum operation result of the first signal and a delay sum operation result of the second signal.

Configuration 7

The ultrasonic sensor according to Configuration 3, wherein

N_{R2} and (N_{R2}+j) have a common divisor α (α being an integer of 2 or more),

N_{R2} is a product of the common divisor α and β,

the processor also is configured to perform an other operation, and

the processor is configured to perform processing based on a signal obtained from the plurality of first elements and a signal obtained from β of the second elements included in the plurality of second elements, the signal obtained from the plurality of first elements corresponding to an other reflected wave of an other ultrasonic wave, the signal obtained from the β second elements corresponding to the other reflected wave.

Configuration 8

The ultrasonic sensor according to any one of Configurations 1 to 7, wherein the plurality of second elements is arranged along the first direction.

Configuration 9

The ultrasonic sensor according to any one of Configurations 1 to 4, further comprising:

a plurality of third elements; and

a plurality of fourth elements,

the plurality of third elements being arranged in a second direction at a third pitch p_{R3},

the plurality of fourth elements being arranged at a pitch of the plurality of fourth elements, a component in the second direction of the pitch of the plurality of fourth elements being a fourth pitch p_{R4},

the processor also performing a second operation,

the second operation including processing based on a third signal and a fourth signal, the third signal corresponding to a second reflected wave of a second ultrasonic wave and being obtained from the plurality of third elements, the fourth signal corresponding to the second reflected wave and being obtained from N_{R4} of the fourth elements (N_{R4} being an integer of 3 or more),

N_{R4}, the third pitch p_{R3}, and the fourth pitch p_{R4} satisfying

p_{R4}/p_{R3}=(N_{R4}+jz)/N_{R4}, and

jz≠nz·N_{R4}/mz,

mz being an integer not less than 1 and not more than kz,

nz being an integer not less than 1 and not more than (mz−1),

jz being an integer not less than 1 and not more than (N_{R4}−1),

kz being an integer not less than 2 and not more than 6.

Configuration 10

The ultrasonic sensor according to Configuration 9, wherein the second direction is aligned with the first direction.

Configuration 11

The ultrasonic sensor according to Configuration 9, wherein an angle between the second direction and the first direction is not less than 80 degrees and not more than 100 degrees.

Configuration 12

The ultrasonic sensor according to any one of Configurations 9 to 11, wherein the processor is configured to output a signal corresponding to a multiplication result, the multiplication result being of a first multiplication result and a second multiplication result, the first multiplication result being of a signal based on the first signal and a signal based on the second signal, the second multiplication result being of a signal based on the third signal and a signal based on the fourth signal.

Configuration 13

An ultrasonic sensor, comprising a plurality of elements,

a first operation being performed, the first operation including processing based on a first signal and a second signal, the first signal corresponding to a first reflected wave of a first ultrasonic wave and being obtained from a plurality of first elements, the plurality of first elements being a portion of the plurality of elements, the second signal corresponding to the first reflected wave and being obtained from N_{R2} second elements (N_{R2} being an integer of 3 or more), the N_{R2} second elements being a portion of the plurality of elements,

the plurality of first elements being arranged along a first direction at a first pitch p_{R1}, the first pitch p_{R1} being in the first direction,

the N_{R2} second elements being arranged at a pitch of the N_{R2} second elements, a component in the first direction of the pitch of the N_{R2} second elements being a second pitch p_{R2},

p_{R2}/p_{R1} being not less than 0.97 times and not more than 1.03 times (N_{R2}+j)/N_{R2}, j not being n·N_{R2}/m, m being an integer not less than 1 and not more than k, n being an integer not less than 1 and not more than (m−1), j being an integer not less than 1 and not more than (N_{R2}−1), k being an integer not less than 2 and not more than 6.

Configuration 14

The ultrasonic sensor according to Configuration 13, wherein

a second operation also is performed, the second operation including processing based on a third signal and a fourth signal, the third signal corresponding to a second reflected wave of the first ultrasonic wave and being obtained from a plurality of third elements, the plurality of third elements being a portion of the plurality of elements, the fourth signal corresponding to the second reflected wave and being obtained from N_{R4} fourth elements (N_{R4} being an integer of 3 or more), the N_{R4} fourth elements being a portion of the plurality of elements,

the plurality of third elements is arranged in a second direction at a third pitch p_{R3}, the third pitch p_{R3} being in the second direction,

the N_{R4} fourth elements being arranged at a pitch of the N_{R4} fourth elements, a component in the second direction of the pitch of the N_{R4} fourth elements being a fourth pitch p_{R4},

p_{R4}/p_{R3} being not less than 0.97 times and not more than 1.03 times (N_{R4}+jz)/N_{R4}, jz not being nz·N_{R4}/mz, mz being an integer not less than 1 and not more than kz, nz being an integer not less than 1 and not more than (mz−1), jz being an integer not less than 1 and not more than (N_{R4}−1), kz being an integer not less than 2 and not more than 6.

Configuration 15

The ultrasonic sensor according to Configuration 14, wherein an angle between the second direction and the first direction is not less than 80 degrees and not more than 100 degrees.

Configuration 16

The ultrasonic sensor according to Configuration 14 or 15, further comprising a processor,

the processor being configured to output a signal corresponding to a multiplication result, the multiplication result being of a first multiplication result and a second multiplication result, the first multiplication result being of a signal based on the first signal and a signal based on the second signal, the second multiplication result being of a signal based on the third signal and a signal based on the fourth signal.

Configuration 17

The ultrasonic sensor according to any one of Configurations 1 to 16, wherein the second pitch p_{R2} is greater than 1/2 of a wavelength of the first ultrasonic wave.

Configuration 18

The ultrasonic sensor according to any one of Configurations 1 to 17, wherein

N_{R2} is 6, and

(N_{R2}+j) is 8 or 10.

Configuration 19

The ultrasonic sensor according to any one of Configurations 1 to 17, wherein

N_{R2} is 8, and

(N_{R2}+j) is 10 or 14.

Configuration 20

The ultrasonic sensor according to any one of Configurations 1 to 17, wherein

N_{R2} is 9, and

(N_{R2}+j) is 12 or 15.

Configuration 21

The ultrasonic sensor according to any one of Configurations 1 to 17, wherein

N_{R2} is 10, and

(N_{R2}+j) is 12, 14, or 18.

Configuration 22

The ultrasonic sensor according to any one of Configurations 1 to 17, wherein

N_{R2} is 12, and

(N_{R2}+j) is 14, 16, 20, or 22.

Configuration 23

The ultrasonic sensor according to any one of Configurations 1 to 17, wherein

N_{R2} is 14, and

(N_{R2}+j) is 16, 18, or 20.

Configuration 24

The ultrasonic sensor according to any one of Configurations 1 to 17, wherein

N_{R2} is 16, and

(N_{R2}+j) is 18, 20, 22, or 28.

According to the embodiments, an ultrasonic sensor that has a wide detection region can be provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in ultrasonic sensors such as elements, processors, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all ultrasonic sensors practicable by an appropriate design modification by one skilled in the art based on the ultrasonic sensors described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An ultrasonic sensor, comprising:
a plurality of first elements; and
a plurality of second elements,
a first operation being performed, the first operation including processing based on a first signal and a second signal, the first signal corresponding to a first reflected wave of a first ultrasonic wave and being obtained from the plurality of first elements, the second signal corresponding to the first reflected wave and being obtained from N_{R2} of the second elements (N_{R2} being an integer of 3 or more) included in the plurality of second elements,
the plurality of first elements being arranged along a first direction at a first pitch p_{R1}, the first pitch p_{R1} being in the first direction,
the N_{R2} second elements being arranged at a pitch of the plurality of second elements, a component in the first direction of the pitch of the plurality of second elements being a second pitch p_{R2},
p_{R2}/p_{R1} being not less than 0.97 times and not more than 1.03 times (N_{R2}+j)/N_{R2}, j not being n·N_{R2}/m, m being an integer not less than 1 and not more than k, n being an integer not less than 1 and not more than (m−1), j being an integer not less than 1 and not more than (N_{R2}−1), k being an integer not less than 2 and not more than 6.

2. An ultrasonic sensor, comprising:
a plurality of first elements; and
a plurality of second elements,
a first operation being performed, the first operation including processing based on a first signal and a second signal, the first signal corresponding to a first reflected wave of a first ultrasonic wave and being obtained from the plurality of first elements, the second signal corresponding to the first reflected wave and being obtained from N_{R2} of the second elements (N_{R2} being an integer of 3 or more) included in the plurality of second elements,
the plurality of first elements being arranged along a first direction at a first pitch p_{R1}, the first pitch p_{R1} being in the first direction,
the N_{R2} second elements being arranged at a pitch of the plurality of second elements, a component in the first direction of the pitch of the plurality of second elements being a second pitch p_{R2},
N_{R2}, the first pitch p_{R1}, and the second pitch p_{R2} satisfying
p_{R2}/p_{R1}=(N_{R2}+j)/N_{R2} (1), and
j≠n·N_{R2}/m (2),
m being an integer not less than 1 and not more than k,
n being an integer not less than 1 and not more than (m−1),
j being an integer not less than 1 and not more than (N_{R2}−1),
k being an integer not less than 2 and not more than 6.

3. The sensor according to claim 1, further comprising a transmitting element,
the first ultrasonic wave being radiated from the transmitting element.

4. The sensor according to claim 1, wherein the first ultrasonic wave is radiated from at least one of the plurality of first elements, from at least one of the plurality of second elements, or from at least one of the plurality of first elements and at least one of the plurality of second elements.

5. The sensor according to claim 1, further comprising a processor configured to perform the first operation,
the processor being configured to output, in the first operation, a first operation signal corresponding to a multiplication result, the multiplication result being of a signal based on the first signal and a signal based on the second signal.

6. The sensor according to claim 5, wherein the processor multiplies a delay sum operation result of the first signal and a delay sum operation result of the second signal.

7. The sensor according to claim 5, wherein
N_{R2} and (N_{R2}+j) have a common divisor α (α being an integer of 2 or more),
N_{R2} is a product of the common divisor α and β,
the processor also is configured to perform an other operation, and
the processor is configured to perform processing based on a signal obtained from the plurality of first elements and a signal obtained from β of the second elements included in the plurality of second elements, the signal obtained from the plurality of first elements corresponding to an other reflected wave of an other ultrasonic wave, the signal obtained from the β second elements corresponding to the other reflected wave.

8. The sensor according to claim 1, wherein the plurality of second elements is arranged along the first direction.

9. The sensor according to claim 5, further comprising:
a plurality of third elements; and
a plurality of fourth elements,
the plurality of third elements being arranged in a second direction at a third pitch p_{R3},
the plurality of fourth elements being arranged at a pitch of the plurality of fourth elements, a component in the second direction of the pitch of the plurality of fourth elements being a fourth pitch p_{R4},
the processor also performing a second operation,
the second operation including processing based on a third signal and a fourth signal, the third signal corresponding to a second reflected wave of a second ultrasonic wave and being obtained from the plurality of third elements, the fourth signal corresponding to the second reflected wave and being obtained from N_{R4} of the fourth elements (N_{R4} being an integer of 3 or more),
N_{R4}, the third pitch p_{R3}, and the fourth pitch p_{R4} satisfying
p_{R4}/p_{R3}=(N_{R4}+jz)/N_{R4}, and
jz≠nz·N_{R4}/mz,
mz being an integer not less than 1 and not more than kz,
nz being an integer not less than 1 and not more than (mz−1),
jz being an integer not less than 1 and not more than (N_{R4}−1),
kz being an integer not less than 2 and not more than 6.

10. The sensor according to claim 9, wherein the second direction is aligned with the first direction.

11. The sensor according to claim 9, wherein an angle between the second direction and the first direction is not less than 80 degrees and not more than 100 degrees.

12. The sensor according to claim 9, wherein the processor is configured to output a signal corresponding to a multiplication result, the multiplication result being of a first multiplication result and a second multiplication result, the first multiplication result being of a signal based on the first signal and a signal based on the second signal, the second multiplication result being of a signal based on the third signal and a signal based on the fourth signal.

13. An ultrasonic sensor, comprising a plurality of elements,
a first operation being performed, the first operation including processing based on a first signal and a second signal, the first signal corresponding to a first reflected wave of a first ultrasonic wave and being obtained from a plurality of first elements, the plurality of first elements being a portion of the plurality of elements, the second signal corresponding to the first reflected wave and being obtained from N_{R2} second elements (N_{R2} being an integer of 3 or more), the N_{R2} second elements being a portion of the plurality of elements,
the plurality of first elements being arranged along a first direction at a first pitch p_{R1}, the first pitch p_{R1} being in the first direction,
the N_{R2} second elements being arranged at a pitch of the N_{R2} second elements, a component in the first direction of the pitch of the N_{R2} second elements being a second pitch p_{R2},
p_{R2}/p_{R1} being not less than 0.97 times and not more than 1.03 times (N_{R2}+j)/N_{R2}, j not being n·N_{R2}/m, m being an integer not less than 1 and not more than k, n being an integer not less than 1 and not more than (m−1), j being an integer not less than 1 and not more than (N_{R2}−1), k being an integer not less than 2 and not more than 6.

14. The sensor according to claim 13, wherein
a second operation also is performed, the second operation including processing based on a third signal and a fourth signal, the third signal corresponding to a second reflected wave of the first ultrasonic wave and being obtained from a plurality of third elements, the plurality of third elements being a portion of the plurality of elements, the fourth signal corresponding to the second reflected wave and being obtained from N_{R4} fourth elements (N_{R4} being an integer of 3 or more), the N_{R4} fourth elements being a portion of the plurality of elements,
the plurality of third elements is arranged in a second direction at a third pitch p_{R3}, the third pitch p_{R3} being in the second direction,
the N_{R4} fourth elements being arranged at a pitch of the N_{R4} fourth elements, a component in the second direction of the pitch of the N_{R4} fourth elements being a fourth pitch p_{R4},
p_{R4}/p_{R3} being not less than 0.97 times and not more than 1.03 times (N_{R4}+jz)/N_{R4}, jz not being nz·N_{R4}/izmz, mz being an integer not less than 1 and not more than kz, nz being an integer not less than 1 and not more than (mz−1), jz being an integer not less than 1 and not more than (N_{R4}−1), kz being an integer not less than 2 and not more than 6.

15. The sensor according to claim 14, wherein an angle between the second direction and the first direction is not less than 80 degrees and not more than 100 degrees.

16. The sensor according to claim 14, further comprising a processor,
the processor being configured to output a signal corresponding to a multiplication result, the multiplication result being of a first multiplication result and a second multiplication result, the first multiplication result being of a signal based on the first signal and a signal based on the second signal, the second multiplication result being of a signal based on the third signal and a signal based on the fourth signal.

17. The sensor according to claim 1, wherein the second pitch p_{R2} is greater than 1/2 of a wavelength of the first ultrasonic wave.

18. The sensor according to claim 1, wherein
N_{R2} is 6, and
(N_{R2}+j) is 8 or 10.

19. The sensor according to claim 1, wherein
N_{R2} is 8, and
(N_{R2}+j) is 10 or 14.

20. The sensor according to claim 1, wherein
N_{R2} is 9, and
(N_{R2}+j) is 12 or 15.
